(19) United States
(12) Patent Application Publication
(10) Pub. No.: US 2008/0314908 A1
(43) Pub. Date: Dec. 25, 2008

(54) Tank For Storing of Fluid, Preferably For Fluids at Low Temperatures

(75) Inventors: Kåre Bakken, &Aring;ros (NO); Pål G. Bergan, Nesøya (NO)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: DET NORSKE VERITAS AS, Hovik (NO)

(21) Appl. No.: 11/630,438

(22) PCT Filed: Jun. 24, 2005
(86) PCT No.: PCT/NO2005/000229

§ 371 Date: Dec. 31, 2007

(30) Foreign Application Priority Data
Jun. 25, 2004 (NO) 20042678

(51) Int. Cl. F17C 1/02; F17C 3/04; F17C 13/00; B65D 90/02; B65D 90/52

(52) U.S. Cl. 220/560.12; 220/628

(57) ABSTRACT

The invention regards a tank for storing of fluid at low temperature of insulated self carrying plate structure, where the plates comprises a sandwich structure, comprising two surface sheets of a metal or a material with similar properties and a core material with properties allowing for the variation of thermal deformation between the inner and outer surface sheets, which core material also provides for at least partly the insulation of the tank and which provides at least partly the necessary stiffness and strength of the wall. The invention also regard support means for the tank, a sandwich structure for use in a tank, and a method for producing the tank.

The present invention relates to a tank for storing of fluid, preferably fluids at low temperatures, a sandwich structure for use in a tank and a method for producing a tank.

There is a need for storage of Liquefied Natural Gas (LNG) at cryogenic temperature and near atmospheric pressure in all areas of the LNG value chain:

a) Fixed and floating offshore production facilities (liquefaction facility)
b) Onshore production and storage facilities
c) Waterborne transportation on ships
d) Fixed and floating offshore import terminal and possible re-gasification facilities
e) Onshore import terminals and re-gasification facilities

Offshore production facilities and import terminals are representing new areas in the LNG chain and several projects and concepts are currently being investigated. For floating production facilities and import terminals the tanks will experience different degrees of filling rates which may represent a problem to some tank systems. Due to the wave induced motions of the structure, waves and dynamic motion of the fluid will develop inside a partially filled tank giving high dynamic pressures on the tank structure. This important effect called sloshing may represent a structural problem to most of the existing tank concepts.

For offshore production facilities, the shape of the tank is important as the tanks normally would be located inside the structure with the processing equipment located on the deck above the tanks. Prismatic tanks are preferred as they give the best utilisation of the volume available for the tanks. Another aspect which is important for the offshore production facilities is the fabrication and installation of the tanks. Prefabricated tanks which can be transported to the construction site in one piece or a low number of pieces offers reduced overall construction time and by that reduced cost. A fully prefabricated tank can also be leakage tested prior to the installation. The construction of a membrane tank systems is complicated and need to be done on the construction site inside a finished structure giving a construction time of typically 12 months, or more.

For waterborne transport on ships, two main tank systems are dominating the market; the Moss spherical tank system and the membrane tank systems developed by GTT (Gaz Transport et Technigaz, France). The self-supporting SPB tank developed by IHI (Ishikawajima-Harima Heavy Industries Co., Ltd., Japan) is yet another possible system. The maximum size of LNG ships delivered today are in the range 138 000-145 000 m³ while the market demand now ships in the range 200 000-250 000 m³. These ship sizes may represent a design challenge for the existing tank systems. Long construction time is one of the main problems for the existing tank systems. Typically construction time for a 145 000 m³ LNG ship is around 20 months or more with the construction and testing of the tank systems as the dominating bottleneck. A new challenge for the tank systems is introduced in connection with planned offshore loading and unloading giving a need to design the tanks for partially filling and associated dynamic sloshing pressures.

The Moss spherical tank concept was initially developed during 1969-1972 using aluminium as the cryogenic material. The design is an independent tank with a partial secondary barrier. The insulation is normally plastic foam applied to the outer surface of the tank wall. For ships and offshore facilities the spherical tank concept has relative low utilising off a restricted volume and it is not suited for having the possibility to have a flat deck on offshore facilities.

The development of the membrane tank systems was started in 1962 and has been further developed by Technigaz. Today the systems consists of a thin stainless steel or Invar steel primary barrier, an insulation layer of Perlite filled plywood boxes or plastic foam, an Invar steel or Triplex secondary barrier and finally a secondary layer of insulation. The stainless steel membranes are corrugated in order to handle the thermal contraction and expansion of the membrane while the Invar steel membrane does not need any corrugation. With respect to construction, the system is rather complicated with a lot of specialized component and a substantial amount of welding. The welding of the membranes and the corrugations gives variations in stress concentrations and stress variations due to sloshing all with associated possible cracking due to fatigue, give a potential high risk for leakages. Liquid sloshing due to wave induced motions of the vessel for partially filled tanks is a limitation for these tanks; typically no fillings between 10% and 80% are allowed in seagoing conditions. Sloshing generally gives very high dynamic pressures on the interior tank walls, particular in corner areas, which may cause damage to the membrane and underlying insulation. Another concern is that inspection of the secondary barrier is not possible.

The SPB tank developed by IHI is an independent prismatic tank with a partial secondary barrier designed as a traditional orthogonally stiffened plate and frame system. The system consists of plates and a stiffening system consisting of stiffeners, frames, girders, stringers and bulkheads as in a traditionally designed ship structure. Due to these structural elements, sloshing is not considered to be a problem. Fatigue may have been considered to be a problem for this tank system due to the significant amount of details and local stress concentrations. Insulation is attached to the outer surface of the tank and the tank rests on a system of wooden block supports.

Mobil Oil Corporation has developed a box-like polygonal tank for storing of LNG on land or on ground based structures, described in patent application PCT/US99/22431. The tank is comprised of an internal, truss-braced, rigid frame having a cover on the frame for containing the stored liquid within the tank. The internal, truss-based frame allows the interior of the tank to be contiguous throughout to sustain the dynamic loads caused by the sloshing of stored liquid which is due to the short excitation caused by seismic activity. The tank is prefabricated in sections and assembled on site. The tank structure has a number of details and stress concentrations which is a consideration with respect to fatigue life.

For onshore import terminals and re-gasification facilities, the market is dominated by cylindrical tanks constructed as single containment, full containment or double containment tanks. A single containment tank comprises an inner tank and an outer container. The inner tank is made of cryogenic material, usually 9% Ni steel, and is normally a cylindrical wall with flat bottom. Pre-stressed concrete and aluminium has also been used for the inner tanks. The outer container is generally made of carbon steel which only has the function of keeping the insulation in place and does not provide significant protection in the event of a failure of the inner tank.

The majority of LNG storage tanks built recently around the world is designed as double or full containment tanks. In these designs, the outer tank is designed to contain the full amount of the inner tank in case of a failure of the inner tank. For full containment tanks, the outer tank or wall is normally constructed as a pre stressed concrete wall distanced 1-2 m from the inner tank with insulation material in the spacing. Traditionally built onshore LNG tanks are expensive, have a construction time of about 1 year and have to be built on the location requiring substantial local infrastructure.

As explained, there are two main types of self-carrying, large scale, low temperature tanks in use: (1) spherical tanks resting on a cylindrical support structure, and (2) prismatic tanks with stiffening system inside. In the case of spherical tanks the structural strength is provided by the curved shell action whereas the strength of the prismatic tanks relies extensively on internal frames and beams. In both cases the thermal insulation is provided by a protective layer with low thermal conductivity at the outside of the tanks.

### Purpose

The main purpose of the present invention is to provide a new type of highly efficient, self-carrying low temperature tank where the strength of the tank is extensively achieved by a single element of the wall of the tank.

Another aim is to provide a tank construction capable of being adapted to different surrounding spaces, as cargo holds in ships, containment spaces on floating platforms, segmented spaces at land-based plants, etc

Another purpose of the tank system is to reduce the problem of damage due to internal fluid sloshing for tanks that are onboard ships or floating installations.

A further aim is to provide a self-carrying tank that can be prefabricated in parts or in total and that can be transported and lifted into final location and position, e.g. onboard ships, floating terminals or sites on land.

Another aim is to provide a low temperature tank system that has enhanced operational capabilities in terms of improved fatigue performance, design life and ease of inspection.

A further aim is to develop a tank system that is economically competitive with current tank systems.

The invention also has the aim of providing a support system that provides sufficient support for the floor part of the tank in order for it to sustain the loads from the fluid in the tank. A further purpose of the support system is to provide for the inevitable thermal deformation during the cycle of being filled and empty.

### General Part

These aims are achieved with the invention as defined in the following claims.

The invention regards a tank or containment system for storage of liquids for instance at very low temperatures, i.e LNG or similar fluid. It may also be favourable to use the tank according to the invention also for storage of other kinds of fluid, as for example oil, crude oil, chemicals or other fluids. One type of application would be fluid at relatively high temperatures, e.g. heated bitumen. The tank wall comprises a sandwich structure including two surface sheets with a structural core material in between. By sandwich it should be understood the normal meaning of a sandwich, a multitude of layers connected or bonded to each other and thereby transferring loads between the layers. The core material in the sandwich according to the invention essentially provides at least sufficient strength and stiffness to support the surface sheets against buckling and lateral pressures, it also has sufficient strength to carry the local membrane, bending and shear forces. The core material provides at least partly the insulation of the tank.

In a preferred embodiment the core material will provide sufficient overall strength for the tank system to sustain all types of overall loading including the loading conditions due to thermal contraction, hydrostatic loading, and dynamic loading including dynamic effects from the internal fluid. In the preferred embodiment the core material also provides some of the insulation of the tank.

In a preferred embodiment of the invention, the tank has a mainly cylindrical standing wall comprising the sandwich structure with metal plates and a lightweight concrete core. The roof and floor of the tank may have the same sandwich structure or have another structure. The root structure may alternatively be of completely different type, such as a light weight space frame. There may in other embodiments also be different structures in the roof and floor of the tank.

The internal liquid pressure in the cylindrical standing tank introduces tension stresses in the circumferential direction of the cylinder. Due to the small tension strength of the concrete, crack will occur in the radial vertical planes. Hence, the concrete will not be a significant part of the structural stiffness and the strength of the tank in the circumferential direction. The concrete core will transfer a part of the load from the internal pressure to the external metal layer. The concrete is in compression in radial direction of the cylinder which means that the concrete has sufficient strength. The vertical cracks will have no influence on the structural strength in the radial direction. The calculation of hoop stress in the cylinder will therefore be based on the structural strength of the two metal layers. Gas detection systems may in particular be applied in the joints between pre-fabricated modules of the tank.

A benefit that the structure with a sandwich layer in the wall of the tank gives is that there is inherent gas detection availability in between the layers of the sandwich. In case of a leakage through the inner metal layer, the external layer will act as a second barrier.

The sandwich structure may in the height of the tank vary in thickness of one or several of the layers and also in the overall thickness of the sandwich.

The core material of the sandwich may provide some or in one form of the invention all the insulation necessary for a tank according to the invention. For a LNG tank the core material typically provides only some of the insulation of the tank, and there will be an outer insulating layer outside of the sandwich structure. For other uses of a tank according to the invention the core layer may provide more or all of the insulation of the tank. Typically in a LNG tank temperature drop in the external insulation layer will be larger than in the sandwich structure part of the system.

The tank system may in addition to variations in the sandwich structure also have different overall forms in which main parts may be singly curved, doubly curved, or planar, or any combination of these. Pure spherical, cylindrical or prismatic tanks are special cases of the overall principle. The surface metal sheets of the sandwich structure may be parts of the same geometric shape, or, they may be one type on the inside and another type on the outside, such as curved on the inside and planar on the outside.

A further advantage of enhanced structural efficiency is achieved by curving parts of the tank, internally and/or externally, such that a “shell type” carrying mechanism can be achieved. A particular feature is that this purpose may be combined with another purpose of achieving high volume efficiency; that is, for the tank volume to be able to fill out as much as possible of surrounding spaces that typically are segmented in hexahedral or prismatic volumes.

The aforementioned internally curved surfaces provide a smooth surface that the moving internal fluid can follow without meeting discrete geometric corners that can lead to build-up of very high fluid dynamic pressures. In conjunction with this the fact that the core has a significant structural stiffness and strength and thereby supports adequately the internal sheet, reduces the likelihood of sloshing damage to the tank structure.

The core material which serves the dual function of partly thermal insulation and structural stiffness and strength has a thickness that is sufficiently large to serve both purposes fully or partly. Various types of materials may be applied for the core as long as they have suitable properties in terms of stiffness, strength, thermal conductivity and thermal expansion (contraction) coefficient. Typically the material mix may consist of fine grain components and larger granular components submerged in a matrix material. The fine grain components may be various types of sand or various inorganic or organic materials. The larger components are typically porous grains that provide strength and insulation at low weight. Such aggregates may be expanded glass, it may be burnt and expanded clay, or it may be other types of geo-materials or organic materials such as plastics. Some examples of commercial aggregate materials are Perlite, Liaver, Liapor, Leca, etc. The binder of the matrix material may be one or several of typical binder materials such as cement paste, silica, polymers, or any other material that would serve well in the current context. Special chemical components may also be added to the paste in order to achieve special properties such as desired viscosity, shrinkage reduction or volume control, right speed of hardening, fatigue performance etc. Metallic, inorganic or organic fibres may also be added to the mix to achieve higher strength, particularly in tension.

The core material may either be placed in fluid form directly between sheets that make out the formwork for the casting. Alternatively the core material may in part be prefabricated as plates or blocks that are grouted or glued to the sheets and to each other. The core may consist of different layers of glued plate material through the thickness. The different layers through the thickness may have different properties, for instance different thermal conductivity. The core material may also vary from one part of the sandwich structure forming the tank to the other.

There are several types of known materials that can satisfy the requirements of the current invention. One example is ultra-lightweight concretes with aggregates of the types mentioned above. Another example is core plates made of sintered Liaver that are glued together and against the sheets. Special types of plastic foams may also be applied. Some selected properties of some of these materials are typically:

| | | Thermal | | |
|---|---|---|---|---|
| | | Conductivity | Young's | Compressiv |
| | Density | at 20° C. | Modulus | Strength |
| | [kg/m³] | [W/(mK)] | [MPa] | [MPa] |
| Lightweight | 350-1000 | 0.13-0.21 | 1000-6000 | 4-16 |
| concrete | | | | |
| Sintered Liaver | 265 | 0.08 | 94 | 1.2 |
| Divinycell | 200-400 | 0.03-0.06 | 150-340 | 4-11 |
| Polyurethane foam | 60 | 0.026 | | 0.2 |
| High density | 160-500 | 0.025-0 04 | 12-30 | 3-48 |
| Polyurethane | | | | |

The thickness of the core material depends on the size of the tank as well as on the specific properties of the core. In small tanks the core may be 10-20 cm whereas large tanks may have core thickness of more than one meter.

A special consideration for the core material, in addition to structural and insulating performance, is that it should provide necessary compliance for the difference in thermal deformations between the inner and outer sheets of the sandwich. This may partly be achieved through the low modulus of elasticity of the core material. In addition it should be noted that tension cracking may typically occur in core materials like lightweight concretes described above. Preferably such cracking should consist of micro-cracks rather than few discrete cracks with large openings. The main objective is that the necessary combined sandwich strength should be maintained even with presence of cracks. This type of performance may be achieved through careful mix design of the core material with, if necessary, special chemical or fibre type additives, as described in relation to the preferred cylindrical embodiment as mentioned above.

The inner sheet is typically made of a metal or a material with similar properties that has sufficient strength as well as resistance to the thermal and chemical environment of the fluid stored in the tank. In the case of LNG containments the material may be 9% Nickel steels or austenitic stainless steels like 304, 304L, 316, 316L, 321 or 347. Other types of metals, aluminium alloys or Invar steel, or composites may also be used. The outer sheet is typically not exposed to the same harsh thermal and chemical environment as the inner sheet, and it may in some instances be made of for instance a simpler type of carbon structural steel. For the inner as well as the outer sheet applies that the material must be suitable for joining, such as welding, and have sufficiently good bonding properties to the core material or to the binder of core blocks. The thickness of the metal sheet may also vary along the wall of the tank, for instance from bottom to the top part of the wall of the tank. Also the core material may have a variation in thickness from one part of the wall to another part of the wall, for instance from bottom to top of the cylindrical wall of the preferred embodiment.

In addition to the dual function of the core material, the fact is that the core material itself is relatively inexpensive; another positive aspect is that the material thicknesses of the internal and external sheets are relatively thin. Notably it is the inner sheet that typically is a main cost element for low temperature tanks; this sheet is typically made of expensive high grade metal alloy sandwich. This implies that the sandwich construction is in itself a very efficient design compared with stiffened plate constructions, and cost competitive with other solutions.

This sandwich structure is a particular feature for the present invention, and this has not been found in relation with prior tanks used for storing of fluid at very low temperature.

A feature of the sandwich construction is that there may be a grid of stiffeners between the surface sheets. The purpose of this internal stiffening system is that it gives additional strength to the core material such that the combination of the two gives sufficient strength even though the type of core material used per se may be too weak. Another purpose of internal stiffeners may be to facilitate the production process by way of providing a framework for mounting the surface sheets. Another purpose may be to ensure sufficient bonding and anchorage of the surface plates to avoid sheet buckling and delamination.

The grid stiffeners may be rod like elements, but preferably plate like elements in contact with both surface sheets of the sandwich structure. The plate like elements may be longitudinal and running in a grid system with intersections of different plate elements.

The internal grid of stiffeners may be designed such that the thermal leakage through the stiffeners themselves is reduced. The reduction of thermal leakage may be done by removing some of the material at the mid-zone of the stiffeners as recesses or cut-outs such that there is a reduced area for thermal conduction by way of the stiffeners. Non-metal materials with reduced thermal conductivity may also be used in parts of the internal stiffeners. This may also promote the ability of the stiffening system to allow for thermal deformations.

In one embodiment of the invention the stiffener grid system may extend from the inside to the outside of the sandwich wall construction. In this way additional stiffness and strength may be provided to the overall containment system. It is also to be noted that in this case inexpensive, non-structural insulation material, e.g. isopor, glass-wool, or rock-wool, may be added to the outside of the sandwich wall as well as to cover and insulate the protruded stiffeners themselves.

The production method for the tank system is important for practical reasons as well as for the overall economy. Pre-production in modules or in total implies reduced construction time and that tank production can go in parallel with construction of the rest of the vessel, platform or site where the tanks are going to be finally located. For instance, in the case of a primarily prismatic tank, the plates forming the side walls, the roof and the floor parts may be produced as modules that are assembled before or after the parts are brought to the final installation site. In the case of a cylindrical or near-cylindrical form the walls may be produced as rings that are stacked and attached on top of each other. Use of angular, sectional elements provides another approach.

It is also to be noted that the tank system as such is scalable, i.e. it can be scaled up to very large dimensions and storage capacity. The possibility of transporting and lifting or skidding very large tanks into position is mainly a question of transport and moving capacity, and the possibility of pre-production of elements forming the tank gives a substantial benefit to the tank according to the invention.

The tank can extensively be equipped for its operational purpose including filling and discharge system, monitoring systems etc.

The invention also covers support means for the tank. The support means provide sufficient support for the floor part of the tank in order for it to sustain the loads from the fluid in the tank. The support means also provide for the inevitable thermal deformation during the cycle of being filled and emptied. This implies that relative radial motion should be allowed in relation to a chosen fixed point in the support system. This point may be centrally located under the tank system or at a different position, or the point will normally be below the entry point for the filling and emptying equipment. The support means may also included lateral structural supports at one or several points along the side walls. Such supports may be an effective way of increasing the overall strength of the tank when the tank is integrated in for instance a ship hull or in a floating terminal. Such support means may reduce the internal stresses and deformations in the tank walls and may also provide overall structural support during dynamic motion on the sea. These support means should be designed such that they allow for relative displacements between the tank and the support structure during thermal deformations at the same time that they provide the intended lateral support. In the case of land-based tanks a different consideration may be to provide base isolation in case of earthquakes; the object of this is that the tank should be able to “float” on top of the support means without being forced to follow the ground motion of the earthquake. In this way the tank will not have to sustain the full inertia forces that could be carried over from the earthquake. The support means may thus comprise flexible layers or components that allow for wanted dynamic compliance. Another possibility for land based tanks is to position it on a bed of sand or pebbles or similar and thereby allowing the inevitable expansion and contraction of the tank structure during filling and emptying of the tank.

In an embodiment of the invention comprises the sandwich structure forming walls, floor and roof means for pre-stressing the structure in at least one direction of the tank structure. This may be done by means of cables anchored to points in the surface sheets, and pre stressed during the assembly of the sandwich structure. Pre-stressing of concrete elements is well known for a skilled person and will therefore not be discussed further more here.

In a tank according to the invention the walls may be formed with a sandwich structure as described, but roof and floor may have a different configuration. The core material and thickness of this and the surface sheets may be varied depending on usage and need. Another element to consider is also the provision of insulation in the core of the sandwich. Thermal insulation may also be provided by an outer insulation layer outside the sandwich structure. One may also have an additional covering layer on the inside of the sandwich in case of for instance corrosive fluids to be stored.

### DETAILED DESCRIPTION

The invention shall now be explained with preferred embodiments with references to the enclosed figures where;

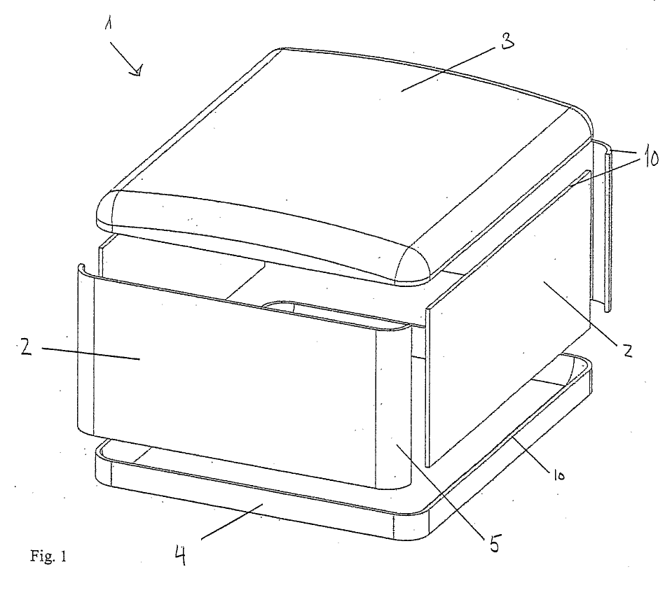

FIG. 1 shows an exploded sketch of a tank according to the invention with side, top and bottom plates forming the tank,

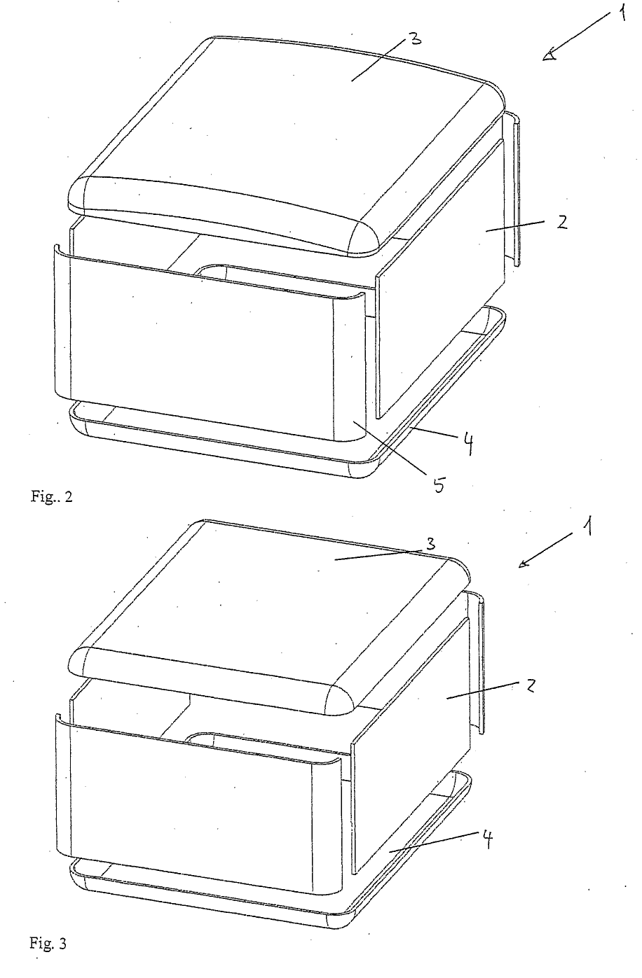

FIG. 2 shows an exploded sketch of a second embodiment of a tank according to the invention,

FIG. 3 shows an exploded sketch of a third embodiment,

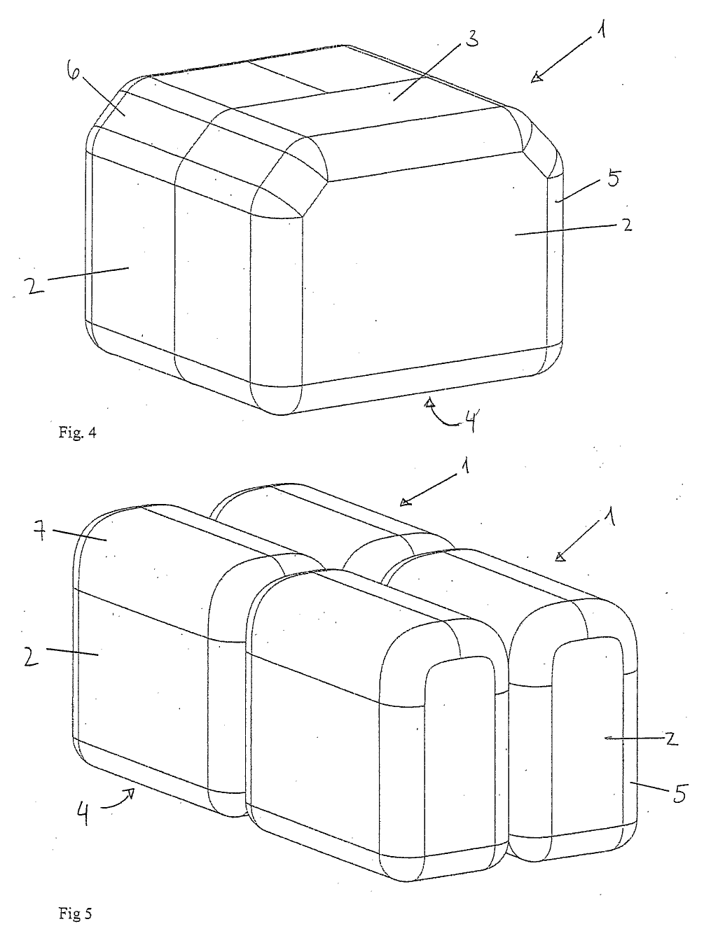

FIG. 4 shows an exploded sketch of a fourth embodiment,

FIG. 5 shows an exploded sketch of a set of four tanks with a fifth embodiment,

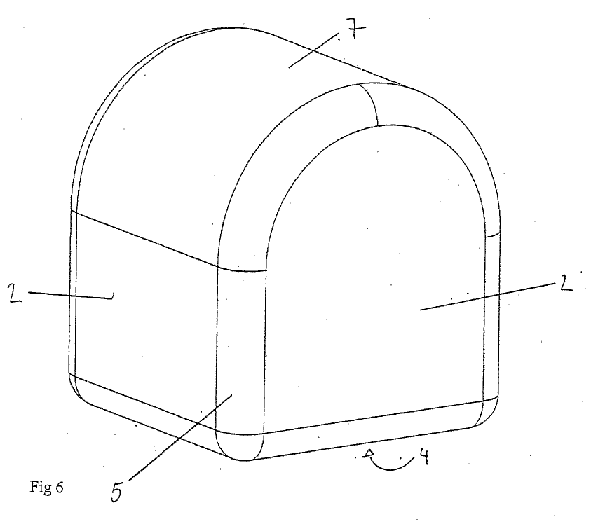

FIG. 6 shows an exploded sketch of a sixth embodiment,

FIG. 7 shows an exploded sketch of a seventh embodiment,

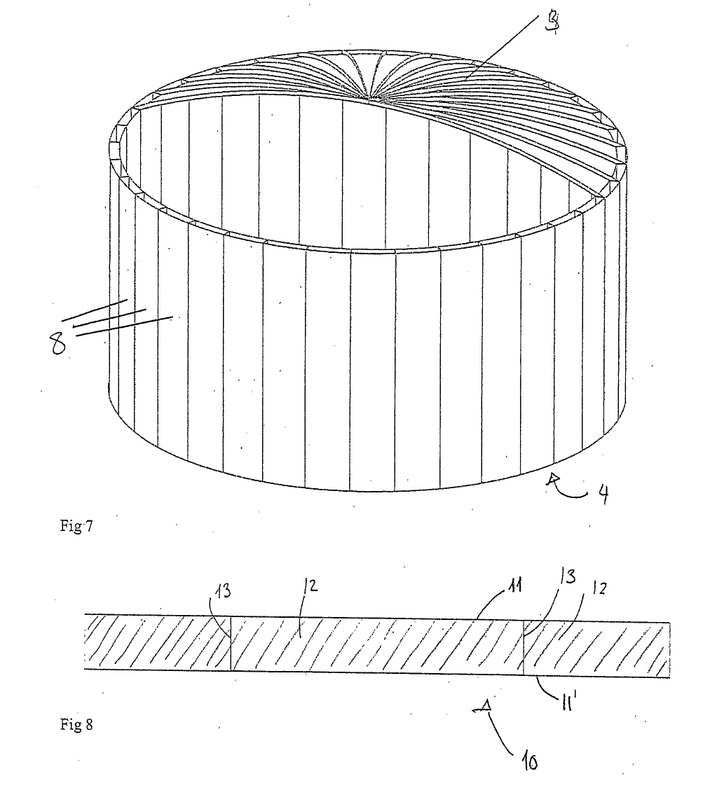

FIG. 8 show a cross section of a plate forming walls, floor and roof in a tank according to the invention,

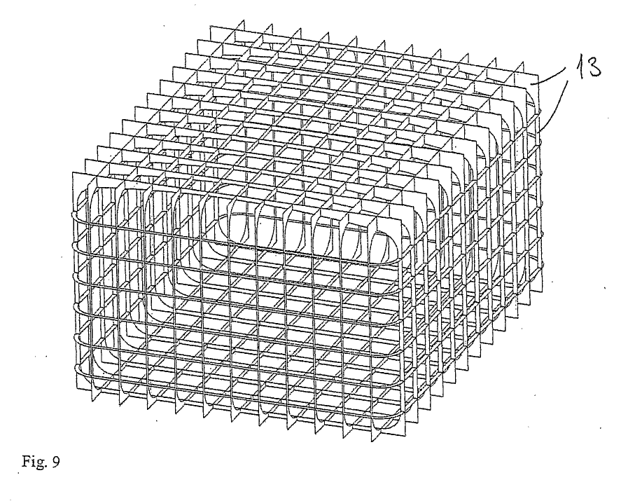

FIG. 9 shows a perspective view of one embodiment of the grid stiffeners in the sandwich structure in a tank according to the invention,

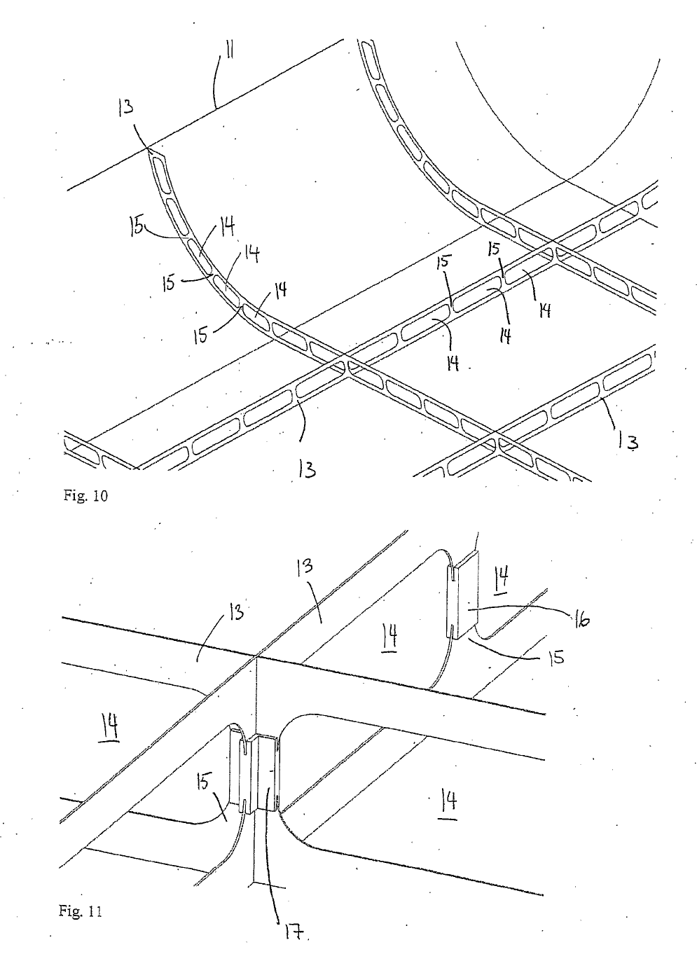

FIG. 10 shows a detailed perspective view of another embodiment of the grid stiffeners and one outer sheet of the sandwich structure in a tank,

FIG. 11 shows a detail of a third embodiment of the grid stiffeners,

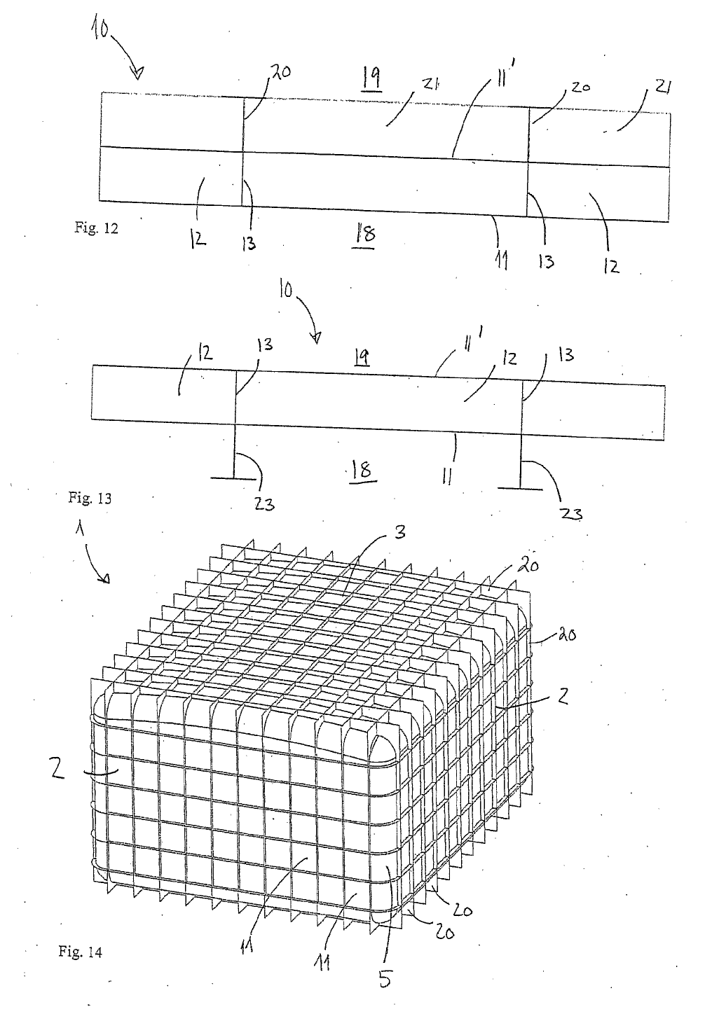

FIG. 12 shows cross section of a second embodiment of a plate forming the walls, roof and floor of a tank according to the invention,

FIG. 13 shows a cross section of a third embodiment of a plate forming the walls, roof and floor of a tank according to the invention,

FIG. 14 shows a perspective view of a tank according to the invention with a wall with external stiffeners,

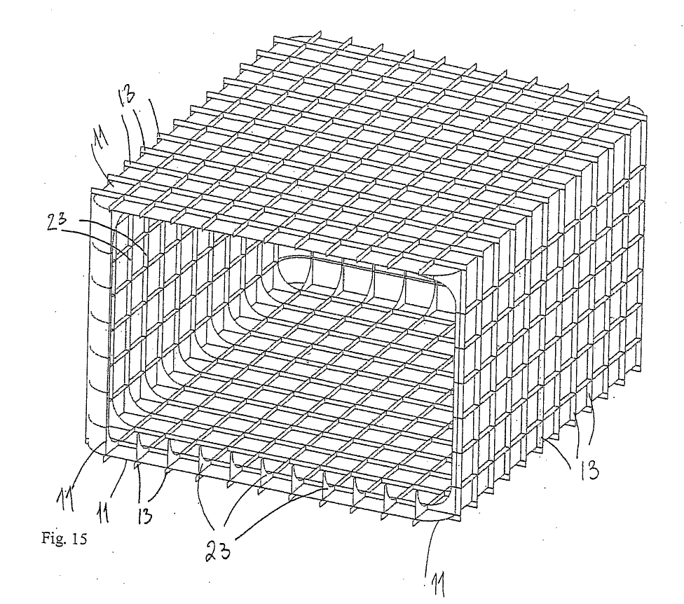

FIG. 15 shows a perspective view of a tank with the outer sheet of the sandwich and one side plate removed, with internal stiffeners.

Same reference numerals for the same parts in the different embodiments are used through the detailed description.

A tank 1 according to the invention comprises a self carrying tank structure capable of withstanding large temperature variation cycles during its life. The self carrying tank structure comprises a sandwich structure 10, which shall be explained in more detail below. According to the invention comprises the tank of side plates or walls 2, a top plate or roof 3 and a bottom plate or floor 4. As shown in FIG. 1 comprises the tank 1 four mainly plane side plates 2, four corner element 5, joining the side plates 2, a slightly curved top plate 3 with rounded elements for joining with the side plates and a plane bottom plate 4 with internally rounded and outwardly right-angled elements for joining the bottom plate 4 with the side plates 2.

FIG. 2 shows a second embodiment with side, top and corner elements equal to FIG. 1 but where the bottom plate 4 is formed with rounded elements for joining it to the side plates. FIG. 3 shows a third embodiment where the top plate 3 is a plane plate. FIG. 4 shows a fourth embodiment where there from two opposite side plates 2 are formed angled top corners 6 joining the side plates 2 to the roof plate 3 of the tank 1. FIG. 5 shows four tanks 1 according to a fifth embodiment where the tanks 1 are formed with a rounded top plate 7 with two curved sections, and in FIG. 6 is a sixth embodiment shown where the top plate 7 is formed in a single curved section. FIG. 7 shows a seventh embodiment with circular side plates 2 comprising circular arc formed plate segments 8 and a doubly curved top plate 3. This embodiment is especially suitable for land based tanks. There is also the possibility of providing circular segments positioned on top of each other for assembling of a cylindrical tank. The roof and floor of a cylindrical tank may be provided by sandwich elements or have a different structural configuration.

In FIG. 8 there is shown a preferred embodiment of a cross section of a plate forming side walls, roof an floor in a tank according to the invention. The plate comprises a sandwich structure 10 with two surface sheets 11,11′ and a core material 12 between the sheets 11, 11′. There are grid stiffeners 13 running from one surface sheet 11 to the other surface sheet 11′. The cross section is shown as a plane plate but may of course be arced to form a circular tank wall, as shown in FIG. 7.

In FIG. 9 is there shown one embodiment of the grid stiffeners 13 where the grid stiffeners 13 are plate elements with a width of the plate running from one surface sheet 11 to the other 11′. The length of the plate element is running parallel to the surface sheet of the sandwich structure. One may see from this figure that the outer surface sheet and the inner surface sheet will have a varying internal distance between them. It can be seen from the width of the grid stiffeners 13 which at the corners of the structure have a larger width than for the rest of the walls. It can be seen form the figure that the inner sheet will have rounded corners and the outer sheet will have right-angled corners, and therefore a varying distance between the surface sheets in the sandwich structure.

The grid stiffeners 13 may be plate elements or rods or other structures running from one surface sheet 11 to the other surface sheet 11′. FIG. 10 shows a detailed perspective view of a second embodiment of the grid stiffeners 13 arranged onto an outer sheet 11 of the sandwich structure. The grid stiffeners 13 are plate like elements running in a grid pattern, and will be in contact with both sheets of the sandwich structure. The grid stiffeners 13 are formed with cut-outs 14 for reducing the thermal conductivity through the grid stiffeners 13. Between the cut-outs 14, which are oval openings with its length stretching in the longitudinal direction of the grid stiffeners 13, there are formed bridge parts 15 of the grid stiffeners 13. Instead of cut outs recesses may be formed which also reduces the thermal conductivity, and increases the structural flexibility of the bridge part.

As shown in FIG. 11 may the bridge parts 15 of the grid stiffeners 13 be formed as separate elements of another material with a lower heat transfer coefficient than the rest of the grid stiffeners 13, and these separate elements may be plate bridge elements 16 connected to the grid stiffeners 13 between two cut-outs 14 in the plate grid stiffeners or a cross bridge element 17 connected to the grid stiffeners 13 in a intersection between two plate elements and the cross bridge element 17 will therefore be arranged between four cut-outs in the grid stiffeners 13.

These bridge elements 16, 17 may be formed as a plate element with grooves in two opposite facing end sides for inserting a part of the bridge part 15 of the grid stiffeners 13, and thereby locking the bridge element 16, 17 to the grid stiffeners.

FIGS. 12 and 13 show two other embodiments of a plate forming walls, roof or floor comprising a sandwich structure, according to the invention. In FIG. 12 comprises the plate a sandwich structure with an inner and 11 outer sheet 11′ and a core material 12 between these. There are also grid stiffeners 13 between the sheets 11, 11′. These grid stiffeners 13 are extended outward from the sandwich structure to the outside of the tank, marked 19, as external stiffeners 26 and there is applied a second insulation layer 21 on the outside of the sandwich structure between the external stiffeners 20. The inside of the tank, marked 18, shows a smooth surface sheet, while the outside 19 of the tank shows external stiffeners 20 with insulation layer 21. The insulation layer 21 may of course be covering the external stiffeners 20 entirely or there may be another or several outer surface layer on the outside. In FIG. 13 is there shown another embodiment where the plate comprises a sandwich structure with an outer 11′ and inner sheet 11 and a core material 12 between these sheets. There are grid stiffeners 13 in the sandwich structure which are extended inwards as internal stiffeners 23 to the inside 18 of the tank. In this embodiment is the outside of the tank a smooth surface, while the inside comprises internal stiffeners 23.

In FIG. 14 there is shown a tank with a sandwich structure equal to the one shown in FIG. 12, but with the outer insulation layer removed. It is shown a tank with side 2, top 3, and bottom plates and rounded corners 5 and the outer sheet 1 of the sandwich with external stiffeners 20 protruding from the outer sheet 11. FIG. 15 shows a tank with the outer sheet of the sandwich and a side plate removed, and one can see the grid stiffeners 13 of the sandwich structure and the inner sheet 11 of the sandwich structure and internally in the tank internal stiffeners 23 protruding into the void of the tank. It is to be noted that any lateral support means as defined earlier normally will be located at one or several of the intersections points between stiffeners in the side walls.

In one embodiment of the invention the plates forming the external tank walls may be connected to and supported by other existing, adjacently located, structural system at one or several points or along line contact areas by elastic links, linear or nonlinear mechanical devices or, pneumatic and or hydraulic devices, or combination thereby. One specific example is arranging the previous described supporting between the side walls and a surrounding structure as for instance a hull of a ship, but there are several other possible solutions for this, as indicated. The lateral support mechanism may support the tank in relation to tilting and or for dampening and reducing the dynamic response of the tank during sea conditions or during earthquakes.

The invention has now been explained with different detailed embodiments; however, it is possible to envisage alteration and amendments in relation to these embodiments within the scope of the invention as defined in the following claims. There may be additional lateral support outside the walls of the tank, especially in the case where the tank is positioned on a moving surface as a vessel or floating platform. The plate forming walls, floor or roof may be a multilayered structure, among where one of the layers is a sandwich structure. There may be additional insulation outside the sandwich structure, partly or wholly covering eventual outer stiffeners.

1-22. (canceled)

23. A tank for storing of fluid preferably for storing fluid at low temperature for instance LNG, the tank comprising means for filling and emptying the tank and means for supporting the tank where at least some of the plates forming walls, roof and floor of the tank are formed as partly insulating self carrying structures, characterized in that the tank has a general standing cylindrical shape, that the partly insulating self carrying structures comprise a sandwich structure, comprising two surface sheets of a metal or a material with similar strength properties and a thermally deformable, insulating core material between the inner and outer surface sheets, and for at least partly insulation of the tank and which together with surface metal plates provides at least partly the necessary stiffness and strength of the wall, that the sandwich structure of the walls of the tank are comprising metal surface sheets and light weight concrete core and that there is an insulating layer outside the sandwich structure.

24. The tank according to claim 23, wherein at least a part of the sandwich structure comprises internal grid stiffeners.

25. The tank according to claim 24, wherein the grid stiffeners comprise plate like elements which stretch from contact with one surface sheet to contact with the other surface sheet, which plate elements comprise means for reducing heat transfer through the plate element.

26. The tank according to claim 23, wherein the core material fully provides for the insulation of the tank.

27. The tank according to claim 23, wherein the inner and outer sheets of the sandwich have different geometrical shape.

28. The tank according to claim 23, wherein the properties of the core material vary for different parts of the tank wall.

29. The tank according to claim 23, wherein the inner surface sheet has different material properties than the outer surface sheet.

30. The tank according to claim 23, wherein the thickness of the sheet materials of the sandwich structure may vary for different parts of the tank.

31. The tank according to claim 23, wherein at least a part of the sandwich structure comprises pre-stressing in at least one direction.

32. The tank according to claim 23, wherein means for supporting the tank comprise guiding means for absorbing movements caused by expansion and contraction of the plates due to thermal variations.

33. The tank according to claim 23 or 32, wherein the plates forming the external tank walls are connected to and supported by other existing, adjacently located, structural system at one or several points or along line contact areas by elastic links, linear or nonlinear mechanical devices or, pneumatic and or hydraulic devices, or combination thereby.

34. A method for manufacturing a tank for storing of fluid preferably for storing fluid at low temperature for instance LNG, the tank comprising means for filling and emptying the tank and means for supporting the tank where at least some of the plates forming walls, roof and floor of the tank are formed as partly insulating self carrying structures, where the tank has a general standing cylindrical shape, that the partly insulating self carrying structure comprise a sandwich structure, comprising two surface sheets of a metal or a material with similar strength properties and a thermally deformable, insulating core material between the inner and outer surface sheets, and for at least partly insulation of the tank and which together with surface metal plates provides at least partly the necessary stiffness and strength of the wall, that the sandwich structure of the walls of the tank are comprising metal surface sheets and light weight concrete core and that there is an insulating layer outside the sandwich structure, said method comprising the steps of producing separate plate segments in transportable sizes, transporting them to the wanted location, and assembling the plate segments to form the tank.
